(19) United States
(12) Patent Application Publication
(10) Pub. No.: US 2008/0173162 A1
(43) Pub. Date: Jul. 24, 2008

(54) Musical Instrument/Computer Interface And Method

(76) Inventor: David Williams, Charlotte, NC (US)

Correspondence Address: HODGSON RUSS LLP;THE GUARANTY BUILDING, 140 PEARL STREET, SUITE 100, BUFFALO, NY, 14202-4040, US

(21) Appl. No.: 12/013,311

(22) Filed: Jan. 11, 2008

Related U.S. Application Data
(60) Provisional application No. 60/884,516, filed on Jan. 11, 2007.

(51) Int. Cl. G10H 7/00; G01C 19/00

(52) U.S. Cl. 84/645; 73/504.02

(57) ABSTRACT

A device and method for use with a musical instrument are described. The invention allows wireless control of a digital-audio-workstation (“DAW”) from the musical instrument. The device and method of the invention may also allow for wireless transmission of the output audio signal from the instrument, thus negating the need to connect the musical instrument to the DAW using a cord or a cable. Wireless transmission may be accomplished via a networking protocol having sufficient bandwidth to accommodate transmission of digital audio signals.

### CROSS-REFERENCE TO RELATED APPLICATION

This application claims the benefit of priority to U.S. provisional patent application Ser. No. 60/884,516, which was filed on Jan. 11, 2007.

### FIELD OF THE INVENTION

The present invention relates to devices and methods of interfacing a musical instrument with a computer. The invention may be used to record music created with the musical instrument.

### BACKGROUND OF THE INVENTION

Recent advances in recording have focused on using a personal computer (“PC”). For a modest investment, a person can purchase recording software that will enable the production of very high-quality recordings that rival the quality achievable ten years ago only via a multi-million dollar studio. Furthermore, the size of PC-based systems, which are often called “digital-audio workstations (“DAW”)), is such that high-quality recordings can be produced in a person's home.

Although a PC-based recording system is inexpensive and compact, there is still a significant amount of manipulation that must occur in order to obtain a desired recording. The various settings that are provided by the software may need to be changed frequently. For example, a drum beat, drummer program, audio card setting, patch on a connected preamplifier and synthesizer may need to be changed as the musician experiments with different sounds.

To change a setting, the software normally requires the use of a mouse. By successive clicking and dragging operations, settings may be changed in order to obtain the desired sound.

Often, a recording engineer manipulates the settings to achieve a desired sound, thereby leaving the musician free to play his/her instrument. However, many musicians will act as both recording engineer and musician. Doing so avoids the need to hire a recording engineer and allows the musician to record at a time when it is most convenient for the musician. A drawback to acting as both musician and recording engineer is that the musician is limited to occupying an area that is an arm's-length distance from the PC. Further, the musician may need to put the instrument aside in order to manipulate settings via the PC mouse. As such, PC-based recording systems tend to limit a musician's ability to fully utilize the PC-based recording system, or limits the musician's ability to create music, or both.

Consequently, there is a need for quicker and easier control over the settings provided by a PC-based recording system. It is, therefore, desirable to provide a means for manipulating the recording settings of a recording system that permits the musician greater ability to occupy portions of a recording studio, and reduces the need for the musician to don and doff his/her instrument.

### SUMMARY OF THE INVENTION

The invention includes a device and method for use with a musical instrument, such as a guitar, that allows wireless control of the DAW from the instrument. The device and method of the invention may also allow for wireless transmission of the output audio signal from the instrument, thus negating the need to connect the guitar to the DAW using a cord or a cable. Wireless transmission may be accomplished via a networking protocol having sufficient bandwidth to accommodate transmission of digital audio signals.

The invention may include a receiver packaged with a USB plug, so that the receiver can be easily connected to the DAW via a Universal Serial Bus (“USB”) port on the PC. The instrument is equipped with a transmitter that is able to communicate with the receiver. A motion sensor in the instrument communicates with the transmitter. By activating the motion sensor, the musician can control the DAW.

The receiver may be packaged with a memory, which may be used to store settings or software desired by the musician. In this manner, a musician need not move his/her PC from one studio to another. The receiver/memory/USB plug package may be moved from one PC to another PC, thereby allowing the musician greater ability to move his/her recording efforts quickly from one studio to another studio.

The invention may enable a musician to sit or stand with the instrument in hand and control the DAW without releasing the instrument. Depending on the range of the transmitter, the musician may be allowed to be distant from the DAW, and still control the DAW. Such freedom of movement should translate to more freedom of expression for the musician.

The invention will be described using a guitar, but it will be recognized that the invention may be used with other instruments. Via the invention, the musician is permitted to wirelessly control a computer. The guitar is fitted with a human interface device, such as a mouse, trackball, touchpad, micro joystick (like older laptops) or a gyration pointing device, or another type of Human Interface Device (“HID”) technology that controls a pointer on the PC. The HID may be located near the volume and tone control knobs so that the musician's hand can manipulate the HID in order to provide selections to the DAW via the transmitter and receiver.

The foregoing and additional advantages and characterizing features of the invention will become apparent upon a reading the following description, including the drawings.

### BRIEF DESCRIPTION OF THE DRAWINGS

For a fuller understanding of the nature and objects of the invention, reference should be made to the accompanying drawings and the subsequent description. Briefly, the drawings are:

FIG. 1 is a diagrammatic view showing the shape of a routed area in one type of guitar;

FIG. 2 is a diagrammatic view of a guitar and showing the location of the routed area of FIG. 1;

FIG. 3 is a schematic diagram of a housing incorporating a circuit board containing components of the invention;

FIG. 4 is a diagrammatic view of the receiver/memory/plug package of the invention;

FIG. 5 is a diagrammatic view of a secondary receiver component of the invention; and

FIG. 6 is a diagrammatic view illustrating the software component of the invention.

### DETAILED DESCRIPTION OF THE INVENTION

An acronym which is believed to aptly identify an embodiment of the invention is Guitar User Interface To Mouse Operation (GUITMO). The invention may be embodied as a device placed in a guitar, bass guitar, or other instrument. The device may include circuitry for transmitting the output audio signal of the guitar digitally to a receiver, which is connected to a PC of a DAW, thus negating the need to connect the guitar to the PC via a cable.

A device according to the invention may include the following components: (1) a housing, which may reside in the guitar, (2) a transmitter, which may reside in the housing, (3) an HID, which may be a motion detector mounted on the guitar, in communication with the transmitter, (4) a receiver which receives signals from the transmitter and communicates the signal to the PC of the DAW, (5) a memory, which may be packaged with the receiver, the memory having software, which may include drivers for the device and user friendly options to assist with setting up the device according to predetermined preferences.

By way of illustration, a device according to the invention will be described herein for use in a Stratocaster type of guitar. Modifications can be made to permit use of the invention with other guitar styles and shapes.

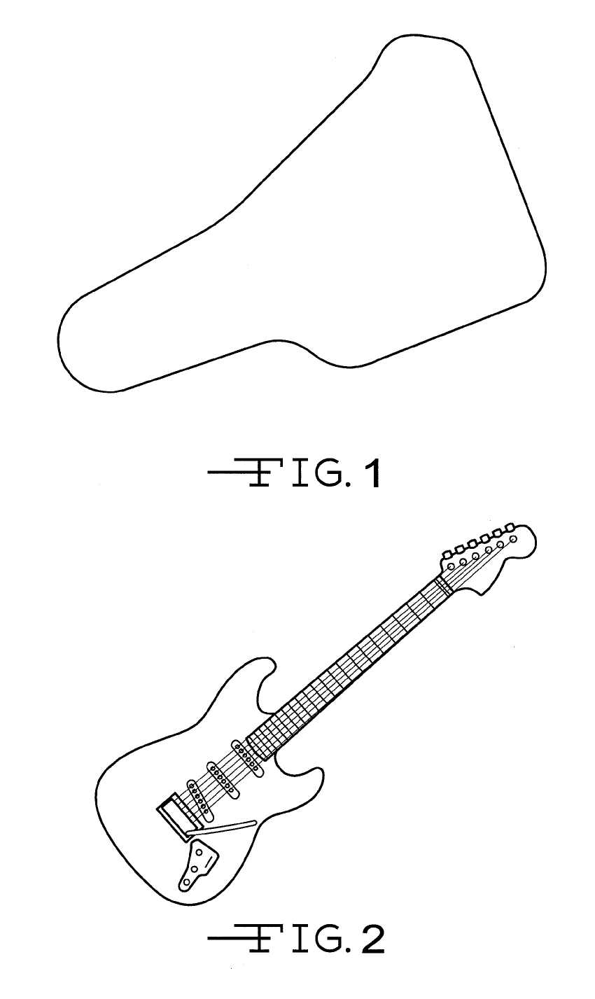

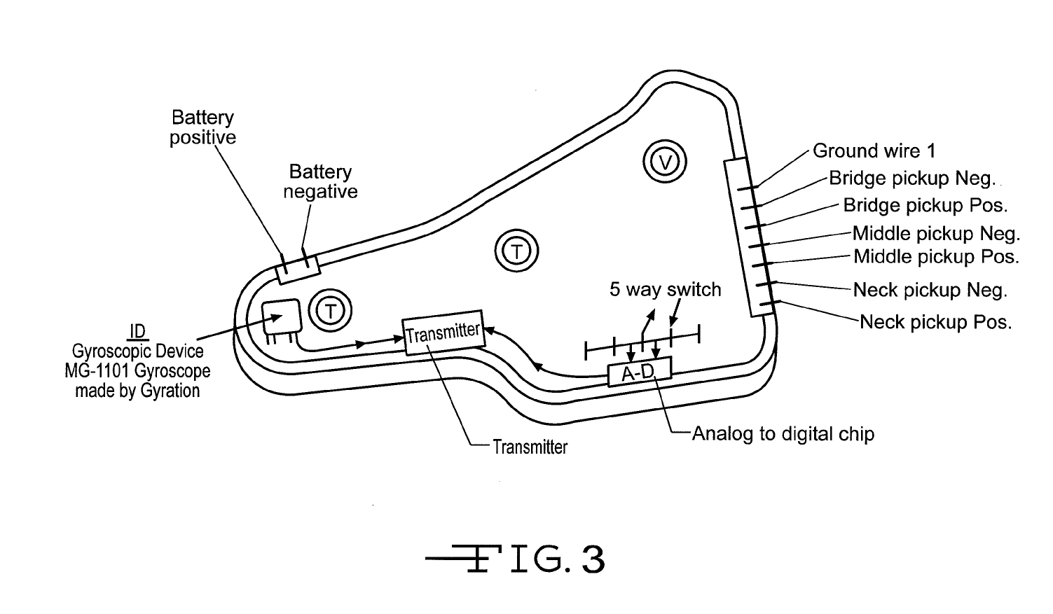

The housing may be made of plastic formed to the shape of the preexisting routed area of the guitar underneath the pick guard of the guitar. The housing may contain a circuit board and permit pins that are associated with the circuit board to extend through the housing in order to allow for quick connection and installation. For the Stratocaster, the routed area is shaped like that shown in FIG. 1. FIG. 2 shows the relationship of the routed area on the guitar and illustrates two types of external manual controls commonly found on an electric guitar—those being two or more potentiometers and a lever switch control. The potentiometers are commonly used to adjust volume and tone of the guitar, while the lever switch control is normally used to toggle between various pick-ups on the guitar.

The circuit board inside of the housing, shown in FIG. 3, may be electrically linked to an HID, and may include an analog-to-digital converter, three potentiometers which each include an additional momentary-depress switch in the middle of the knob, the transmitter, the pin ports to connect six (6) pickup wires (+ and − from each pickup) and one ground wire, two pin ports for + and − of the battery and a five-way lever switch pickup selector.

The circuit board shown in FIG. 3 is wired so that the five-way lever switch and potentiometers are wired the same as a normal Stratocaster guitar, except the positive and negative output wires go to the analog-to-digital converter and then to the transmitter, instead of to the output jack on the guitar. Each potentiometer knob includes a momentary-depress switch. One momentary-depress switch may allow the musician to activate the HID, and thereby toggle between controlling the DAW settings and providing music from the guitar to the DAW. The other two momentary-depress switches may be used to replicate a right-mouse click or a left-mouse click, respectively.

The HID may be a motion detector, which may include an MG1101 Gyroscope to detect movement of the guitar when the musician desires to change settings of the DAW. The gyroscopic motion sensor and the momentary-depress switches may be used in lieu of a mouse in order to point, select and drag icons displayed on a monitor of the DAW.

As an example, when an MG1101 Gyroscope is used as the HID, movement of the guitar will translate into movement of a cursor on the DAW's monitor. So, for example, raising and lowering the neck of the guitar may cause the cursor to move up and down on the monitor. Similarly, moving the neck of the guitar left or right, will cause the cursor to move left or right on the DAW's monitor.

Instead of the MG1101 Gyroscope, another type of HID may be used to move a pointer on the DAW monitor. For example, a trackball may be mounted in the guitar so that a portion of the ball extends above the pick guard and is available for use by the musician. Similarly, a touchpad or joystick may be mounted on the guitar and used by the musician.

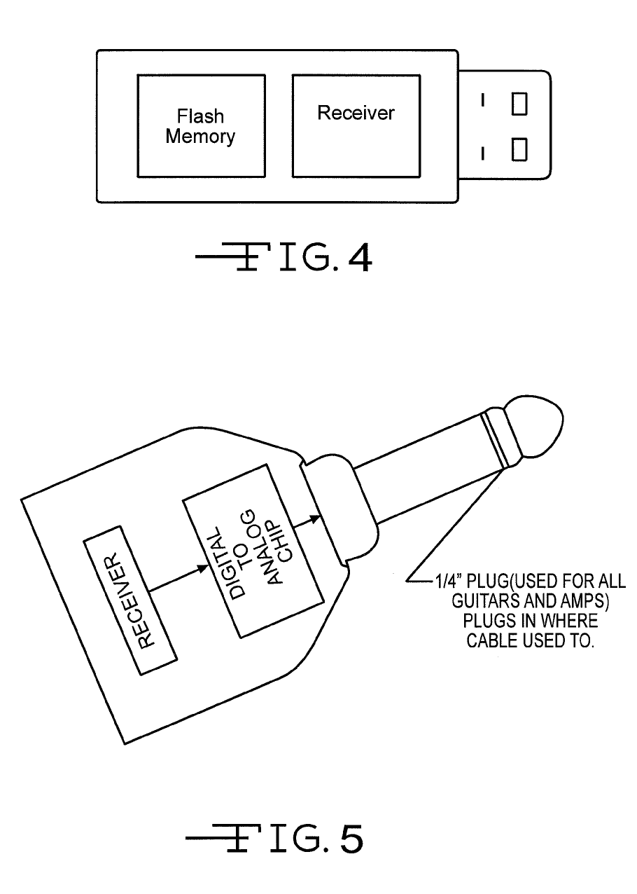

The receiver, shown in FIG. 4, may be used to receive signals from the transmitter. Those signals may be the digital audio signal when the musician is playing the guitar, or may be the control signals intended for changing settings of the DAW.

Packaged with the receiver may be an integrated flash-type memory device. After installing software (discussed below), the receiver may be automatically recognized by the DAW after insertion into a port of the computer. For ease of use, the receiver/memory unit may include a USB plug, which is matable to DAWs having a USB port. The DAW's PC may recognize the receiver/memory unit as three devices: (1) as a sound device, (2) an HID device, and (3) a storage device.

Turning first to the sound device, upon insertion to the USB port, the computer may automatically add the appropriate drivers to recognize digital audio signals to be sent from the guitar. The drivers may be added automatically to the PC controllers section of the PC's device manager. This will enable the musician to select the sound device, and provide music to the DAW.

With respect to the HID device, once the receiver/memory device is connected to the PC, the PC will automatically add the appropriate drivers to recognize manipulation of the HID in a manner similar to how the PC recognizes manipulation of a mouse. Once recognized, the HID may be used by the musician in lieu of a mouse to control and adjust settings of the DAW.

As to the storage device, once the receiver/memory device is connected to the PC, the PC will automatically recognize a mass storage device. The PC will add the appropriate drivers to the disk drives section of the PC's device manager. For example, a G:Drive (“G” for “GUITMO”) will now be accessible by clicking on its icon on the PC's monitor. Software stored in the memory may then be downloaded to the DAW for use by the musician.

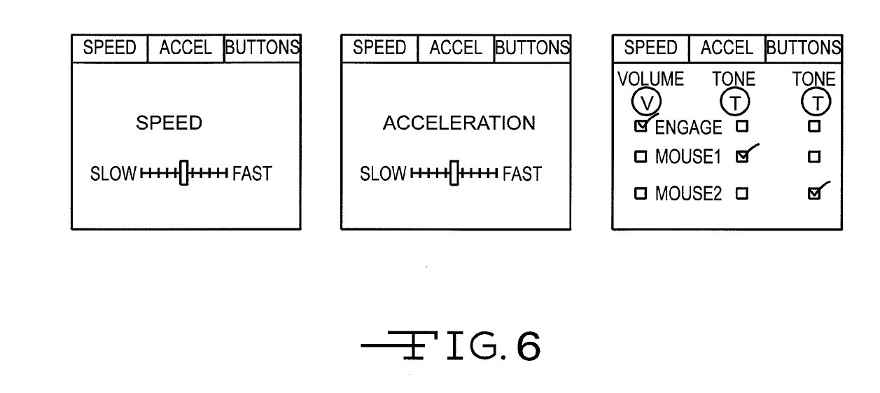

A secondary receiver may be used. FIG. 5 illustrates one such secondary receiver. The secondary receiver may receive the same digital audio signal as the USB receiver. The secondary receiver may have a digital-to-analog converter in order to provide an analog output signal to an amplifier or other equipment. The secondary receiver eliminates the need for expensive so called “True diversity” UHF analog wireless units since digital (not analog) signals are being transmitted from the guitar. FIG. 5 illustrates a possible shape for the secondary receiver. Instead of a cable the guitarist now has just this tiny receiver to plug into his amplifier.

Turning now to the software component of the invention, a device according to the invention may be provided with software. The software can be provided in the receiver/memory package or via a compact disc, or other memory device, downloaded to the PC. FIG. 6 illustrates software according to the invention. The software may include drivers for controlling a device according to the invention. The software may be accessible from a desktop icon or from the control panel of the PC. The software may have tabbed pages allowing the user to adjust the speed and acceleration of the HID and configure the momentary-depress switches (the switches provided in the potentiometer control knobs) to the musician's preferences. To activate the ability to control the DAW, one of the momentary-depress switches may be pressed and held in that position. Having done so, the HID may now be manipulated to adjust settings in the DAW. When the momentary-depress switch is released, the HID will no longer adjust the settings, and instead, the guitar may be used to play music. Alternatively, the HID may be activated by pressing the control switch twice in quick succession, and then deactivated by again pressing the control switch twice in quick succession.

The invention is illustrated further by the following step-by-step instructions for installation in a guitar. The installation is quick, simple and non-destructive to the guitar.
1) Remove guitar strings,
2) Remove jack plate, cut wires to ¼ jack plug.
3) Remove pickguard.
4) Cut or unsolder all pickup wires and ground wire from pots and switch.
5) Remove existing pots and switch.
6) Use crimping pins to attach the six pickup wires and the one ground wire.
7) Line up device housing with existing holes for the three potentiometers and 5 way switch. Attach with shaft nuts.
8) Place knobs on three pot shafts and replace tip of 5 way switch.
9) Push pickup wire pins into pin port at correctly labeled spot.

$$\begin{matrix}. & . & . & . & . & . & . \\ N & N & M & M & B & B & G \\ + & \text{--} & + & \text{--} & + & \text{--} & \end{matrix} \begin{matrix}N = Neck pickup \\ M = Middle pickup \\ B = Bridge pickup \\ G = Ground\end{matrix}$$

10) Feed the 9-volt battery wires through existing hole between jack routed area and housing area and plug wires into +1-labeled area (pins already attached).
11) Replace pickguard.
12) Attach 9-volt battery to the battery cap.
13) Insert battery into old jack compartment and screw on the new face plate.
14) Replace strings.

Upon connecting the receiver/memory/plug package into the PC's USB port, the musician is permitted to play and/or record music generated via the guitar, or is permitted to access his/her favorite DAW programs using the HID mounted on the guitar. Also, one can plug the secondary receiver into an amplifier and jam with digital wireless sound. Further, one can record directly into one's recording software, or equip the amplifier with a microphone and record the amplifier while utilizing the recording software.

It will now be recognized that use of the invention will result in the musician being able to establish a recording studio anyplace there is a computer.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A communication system, comprising:
an HID mounted on a musical instrument;
a transmitter in communication with the HID;
a receiver in wireless communication with the transmitter;
a DAW in communication with the receiver, and allowing the HID to be used to control the DAW.

2. The communication system of claim 1, wherein the HID includes a gyroscopic motion sensor.

3. The communication system of claim 1, wherein the HID includes a track ball.

4. The communication system of claim 1, wherein the HID includes a touchpad.

5. The communication system of claim 1, wherein the HID includes a joy stick.

6. The communication system of claim 1, further comprising a memory device, packaged with the receiver and in communication with the DAW.

7. The communication system of claim 1, further comprising a potentiometer control knob having a momentary-depress switch for activating the HID.
